(19) United States
(12) Patent Application Publication
(10) Pub. No.: US 2025/0165949 A1
(43) Pub. Date: May 22, 2025

(54) DIGITAL RECEIPT GENERATION

(71) Applicant: TARGET BRANDS, INC., Minneapolis, MN (US)

(72) Inventors: Amit BHATE, Maple Grove, MN (US); Sunil KASTURI, Blaine, MN (US); Sean JONES, Minneapolis, MN (US)

(21) Appl. No.: 18/784,444

(22) Filed: Jul. 25, 2024

Related U.S. Application Data
(60) Provisional application No. 63/602,223, filed on Nov. 22, 2023.

(51) Int. Cl. G06Q 20/20

(52) U.S. Cl. CPC G06Q 20/209

(57) ABSTRACT

Techniques for generating electronic copies of receipts (“digital receipts”) are disclosed. The digital receipts can be requested or automatically generated regardless of the environment in which in a transaction is completed. The environment can be an in-store environment where the transaction is performed in a physical store, or the environment may be an e-commerce environment, such as a website or a software application. A receipt service can receive a receipt template for a digital receipt from a receipt database. The receipt service can populate the receipt template based at least in part on some or all of the transaction information associated with the transaction. Once generated, the digital receipt can be transmitted to a receipt delivery device, such as a printer or a computing device.

### CROSS-REFERENCE TO RELATED APPLICATION(S)

This application claims priority to U.S. Provisional Application No. 63/602,223 titled “DIGITAL RECEIPT GENERATION” filed Nov. 22, 2023. The aforementioned application is incorporated herein by reference, in its entirety, for any purpose.

### TECHNICAL FIELD

The present disclosure relates generally to electronic receipts, and more particularly to the generation of electronic receipts.

### BACKGROUND

Many goods and service providers, such as retailers, offer to perform various transactions on multiple platforms. For example, goods and services can be offered at physical or in-store locations, through an application on a smart phone or tablet, and/or through an online portal or e-commerce store through a web browser. Typically, as part of the shopping experience, consumers may receive a receipt or a summary of the transaction (e.g., the purchased goods and services). However, the type of receipt, the format, and the information on the receipt varies depending on the platform where the transaction was completed, which can be confusing for the consumer and may make returns or other post-purchase transactions difficult. Further, for in-store or physical transactions, many retailers provide a printed receipt option. Printed receipts can generate waste, be easily lost by a consumer, and the like. Therefore, there is a need for an improved receipt generation process.

### BRIEF SUMMARY

Embodiments disclosed herein generally relate to the generation of electronic copies of receipts (hereinafter “digital receipts”), where the digital receipts can be requested or automatically generated regardless of the environment in which in a transaction is completed. The environment can be an in-store environment where the transaction is performed in a physical store, or the environment may be an e-commerce environment, such as a website or a software application operating on a computing device.

In one aspect, a method for generating digital receipts can include receiving transaction information corresponding to a transaction conducted in an environment and receiving a receipt template from a memory. As described earlier, the environment can be an in-store environment or an e-commerce environment. The receipt template is populated to include at least a portion of the transaction information. A digital receipt file is generated based on the at least the portion of the transaction information and the receipt template. The digital receipt file is transmitted to a receipt delivery device over a network.

In another aspect, a method for generating digital receipts may include receiving, over a network from a computing device, a digital receipt request and receiving, from a memory, transaction information associated with the digital receipt request. A receipt template is received from the memory. The receipt template is populated to include at least a portion of the transaction information. A digital receipt file is generated based on the at least the portion of the transaction information and the receipt template. The digital receipt file or a link to the digital receipt file is transmitted to the computing device over the network.

In yet another aspect, a system can include a processor and a memory. The memory is configured to store a database and processor-executable instructions. The database is configured to store a plurality of receipt templates. Operations are performed when the processor-executable instructions are executed by the processor. The operations may include receiving transaction information corresponding to a transaction, and receiving, from the database, a receipt template of the plurality of receipt templates. The receipt template is populated to include at least a portion of the transaction information. A digital receipt file is generated based on the at least the portion of the transaction information and the receipt template. The digital receipt file is transmitted to a receipt delivery device over a network.

This summary is provided to introduce a selection of concepts in a simplified form that are further described below in the Detailed Description. This summary is not intended to identify key features or essential features of the claimed subject matter, nor is it intended to be used to limit the scope of the claimed subject matter.

### BRIEF DESCRIPTION OF THE DRAWINGS

Non-limiting and non-exhaustive examples are described with reference to the following Figures. The elements of the drawings are not necessarily to scale relative to each other. Identical reference numerals have been used, where possible, to designate identical features that are common to the figures.

FIG. 1 illustrates a block diagram of an example system for creating digital receipts in accordance with an embodiment of the disclosure;

FIG. 2 illustrates a block diagram of an example system architecture and process flow for creating digital receipts in accordance with an embodiment of the disclosure;

FIG. 3 illustrates a flowchart of a first example method of generating digital receipts in accordance with an embodiment of the disclosure;

FIG. 4 illustrates a flowchart of a second example method of generating digital receipts in accordance with an embodiment of the disclosure;

FIG. 5 illustrates an example printed in-store receipt in accordance with an embodiment of the disclosure;

FIG. 6 illustrates the example in-store receipt shown in FIG. 5 as a digital receipt viewable in a user interface on a display device in accordance with an embodiment of the disclosure;

FIG. 7 illustrates an example of another digital receipt viewed in a user interface on a display device in accordance with an embodiment of the disclosure;

FIG. 8 illustrates and example user interface for requesting a digital receipt in accordance with an embodiment of the disclosure; and

FIG. 9 illustrates a block diagram of an example computing system for implementing various embodiments in the examples described herein.

### DETAILED DESCRIPTION

Consumers can purchase and return goods and services (hereinafter “product” and “products”) via different platforms or environments, such as an in-store environment and an e-commerce environment. For example, a consumer may execute transactions at a physical store (e.g., the in-store environment) and through an application on a smart phone or tablet and/or through an e-commerce store front through a web browser (e.g., the e-commerce environment). A transaction can be associated with a variety of actions, such as a purchase of one or more products, a return of one or more products, and/or another inquiry or inquiries. Example other transactions and inquires include, but are not limited to, a gift card balance inquiry, a payment on an account such as a credit card payment, a rebate receipt, a recall receipt, a decline of a debit or a credit card, and a gift receipt.

Consumers typically receive a receipt of a transaction, but the type of receipt, the format or layout of the receipt, and the information on the receipt can vary depending on the type of the transaction and/or the environment in which the transaction was completed. For example, a receipt for a purchase of products in a retail store can be printed receipt that is arranged in one format and includes an itemized list of the purchased products, information about the return policy, and payment information. Alternatively, an electronic receipt for a purchase made through a web browser can include transaction information arranged in a different layout, such as an image, a description, and a price of each product purchased, a shipping address, and payment information. Additionally, a consumer can receive other types of receipts that are arranged in different layouts and contain different information, such as a receipt for a return using cash or a credit card, a receipt for a purchase or a return using a gift card, a balance inquiry on a gift card, a purchase using a government assistance program (e.g., Special Supplemental Nutrition Program or SNAP), and the like. The different receipts can be confusing for the consumer and make post-transaction actions difficult.

The present disclosure relates generally to the generation of digital receipts. The digital receipts can be requested or automatically created regardless of the environment in which in the transaction is completed. For example, a consumer may receive a digital receipt even though the transaction was completed in person in a physical store. In some embodiments, the digital receipts are generated consistently in the same form, with the same or similar information, regardless of the platform or location where a transaction was completed.

The system may utilize a template database storing receipt templates that can be retrieved and populated based on a user request, the environment associated with the transaction, and/or the location associated with the transaction, as well as the transaction information (e.g., the products purchased, the date and time, the cost, store information, etc.). The digital receipt may be output at a physical location (e.g., printed at a retail store), and/or may be output (e.g., displayed) in digital form (e.g., Adobe® PDF or the like). The layout of the digital receipts may be consistent and include the same information in both environments. In some instances, a consumer (e.g., a user) may select the format of the receipt, e.g., a printed version and/or a digital version, where the selection can be done at transaction time or after the transaction is completed by retrieving the information from a transaction database. With a digital receipt, the user may receive a digital receipt in a particular file format based on a user or a system selection or preference. For example, a user may request to receive a digital receipt in the Adobe® PDF file format, in a hypertext markup language (HTML) file format, or in a joint photographic experts group (JPEG) file format. Alternatively, a user can store one or more receipt layout preferences (or receipt templates) and/or file format preferences in a user profile associated with the user. The receipt layout preference(s) and/or the file format preference(s) may be the same for each environment (e.g., store and e-commerce environments) and/or a receipt delivery device (e.g., printer, software application, etc.), or at least one of the receipt layouts and/or file format preferences may differ from other receipt layout or file format preferences.

In some embodiments, a system architecture can be deployed that allows a same endpoint to be called from both an internal application (e.g., within a store's internal work or point of sale devices) and from a digital application (e.g., a website or an application). In some instances, the request and response will be the same and include the receipt information, but for the digital or external facing requests, the information may further include a consumer identifier to ensure that the correct transaction information is retrieved from the database. In some instances, the requests can be differentiated via request attributes that are included with call information. In other embodiments, separate stacks for the endpoints may be utilized and a gateway can route the request to the correct location.

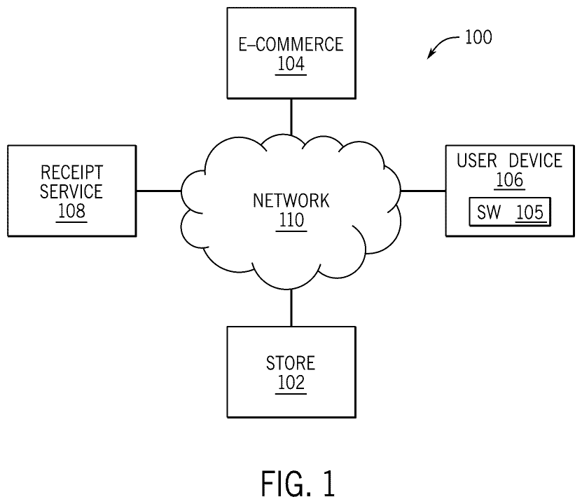

FIG. 1 illustrates a block diagram of an example system for creating digital receipts in accordance with an embodiment of the disclosure. The system 100 may include a store environment 102 that can include information related to in-store transactions, and an e-commerce environment 104 that may include information related to software application purchases and/or web browser-based transactions. The software application purchases can be executed, for example, using a software application 105 on a consumer or user device 106. Example user devices include, but are not limited to, a smart phone, a tablet, a computer, a laptop, a wearable device, or another computing device. The user device 106 may be included as part of a user experience, e.g., to complete e-commerce transactions and/or receive digital receipts. In other embodiments, the store environment 104 and the e-commerce environment 104 are combined to create both a store and an e-commerce environment.

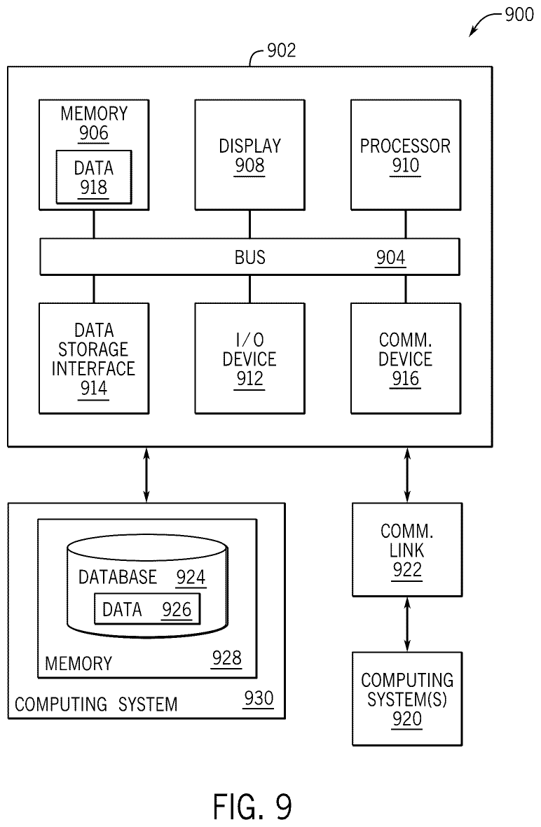

A receipt service 108 or module may be in communication with the various components such as through a network 110, where the receipt service 108 is configured to generate and store the information associated with receipts, such as receipt templates, transaction information, user identification (e.g., a consumer identifier), and the like, to enable the generation of digital receipts. As described earlier, the digital receipts may include similar information and formatting regardless of the transaction environment (e.g., the e-commerce environment 104 or the in-store environment 102). The receipt service 108 can be implemented as a software application or as a collection of distributed software modules operating on a computing device and/or in a computing system (e.g., the computing system 900 or the computing device 902 or 930 in FIG. 9). For example, in one embodiment, the receipt service 108 may be implemented on a server, a mainframe computer, or on a distributed computing system. The network 110 can be configured as one or more systems and protocols for communications between computing devices. Example network systems include, but are not limited to, a wide area network, a local area network, an enterprise private network, the Internet, a cloud-based network, or combinations thereof.

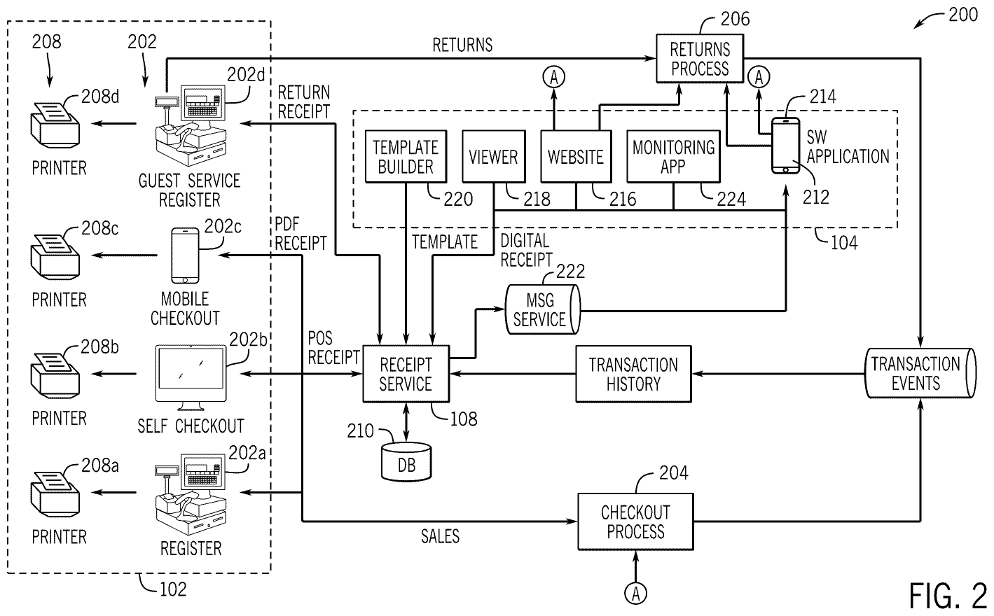

FIG. 2 illustrates a block diagram of an example system architecture 200 and process flow for creating digital receipts in accordance with an embodiment of the disclosure. In some embodiments, the in-store environment 102 may include point of sale (POS) devices 202, such as a register 202a, a self-checkout device, 202b, a mobile checkout device 202c, and a guest service register 202d. The POS devices 202 may receive and complete information for a transaction (“transaction information”). As described earlier, the transaction can be associated with a variety of actions, such as a product purchase (e.g., checkout process 204), a product return (e.g., return process 206), and/or another inquiry (e.g., a gift card receipt, a payment on an account such as a credit card payment, etc.).

Each POS device 202 may be in communication with a receipt delivery device 208. For example, in the illustrated embodiment, the register 202a is in communication with a printer 208a through a wired connection or a wireless connection, the self-checkout device 202b is in communication with a printer 208b through a wired connection or a wireless connection, the mobile checkout device 202c is in communication with a printer 208c through a wired connection or a wireless connection, and the guest service register 202d is in communication with a printer 208d through a wired connection or a wireless connection. Other types of receipt delivery devices and/or POS devices may be included in other embodiments. For example, a messaging application, a display, a software application, and/or an email application on a computing device or a mobile device can be other types of receipt delivery devices.

A receipt template database 210 may be part of the system architecture 200 and may be in communication with or integrated as part of the receipt service 108. The receipt template database 210 may store templates for various types of receipts, such as consumer sale transactions, gift receipts, coupons (e.g., a rain check), parking vouchers, government assistance programs (e.g., SNAP), or the like. The receipt service 108 may include or receive transaction information from the in-store environment 102 and the e-commerce environment 104 and store the transaction information in the receipt database 210. The receipt service 108 is configured to optionally determine a receipt layout, to retrieve a desired receipt template (e.g., a purchase receipt, a gift receipt, a return receipt, etc.) from the receipt template database 210, and to populate the receipt template with the transaction information to create a digital receipt. The digital receipt may then optionally be stored in a database (e.g., the receipt template database or the database 920 of FIG. 9) and/or delivered to a receipt delivery device, such as one or more receipt delivery devices 208 and/or the user device 106 (FIG. 1 or FIG. 2).

The e-commerce environment 104 may include a software application 212 that operates on a user device 214, a website 216, a web viewer 218, and/or a receipt template builder 220. The user device 214 can be implemented as the user device 106 of FIG. 1. The website 216, the web viewer 218, and/or the receipt template builder 220 may each be implemented as a software application operating on a computing device (e.g., a server). The e-commerce environment 104 may be configured to transmit transaction information associated with a transaction to the receipt service 108 during or after the completion of the transaction. The transaction information may also be viewed at the software application 214, the website 216, and/or the web viewer 218. The template builder 220 can be configured to enable a user (e.g., a manager, a system administrator, etc.) to create, manage, and/or store receipt templates in the receipt template database 210.

In some embodiments, a transaction is executed at a respective POS device 202 as part of the checkout process 204. The POS device 202 may be configured to transmit the transaction information associated with the transaction to a respective receipt delivery device 208 (e.g., the printer 208a) and/or the receipt service 108 during or after the completion of the transaction. In one embodiment, the transaction information may be printed as a printed receipt at the respective receipt delivery device 208 and/or stored in the receipt template database 210. In another embodiment, the transaction information can be used by the receipt service 108 to produce a digital receipt that is transmitted to a respective receipt delivery device, such as the website 216 and/or the user device 214 (via the software application 212).

In some embodiments, a transaction is executed at a respective POS device 202 as part of the return process 206. The POS device 202 may be configured to transmit the transaction information associated with the transaction to a respective receipt delivery device 208 and/or the receipt service 108 during or after the completion of the transaction. In one embodiment, the transaction information may be printed as a return receipt at a respective receipt delivery device 208 and/or stored in the receipt template database 210. In another embodiment, the transaction information can be used by the receipt service 108 to produce a digital receipt that is transmitted to a respective receipt delivery device, such as the website 216 and/or the user device 214 (via the software application 212).

In some embodiments, a transaction is executed in the e-commerce environment as part of the checkout process 204 (via the connector A) and/or as part of the return process 206. For example, a user may purchase products and/or return products using the software application 214 or the website 216. The software application 214 and the website 216 may be configured to transmit the transaction information of the transaction to a respective receipt delivery device and/or the receipt service 108 during or after the completion of the transaction. In one embodiment, a digital receipt may be transmitted to a receipt delivery device and/or stored in the receipt template database 210. For example, the receipt delivery device may be the website 216 and/or the software application 214.

In some instances, a user may request a digital receipt be provided to a user device (e.g., the user device 106) at the same time as a transaction is in process or is completed, or sometime after the transaction is completed (e.g., a day, a week, etc.). The digital receipt request can be submitted, for example, using the software application 214, the website 216, or a respective POS device 202 (e.g., the guest service register 202d). The digital receipt request may include a transaction identifier (e.g., a bar code), a date, a product, and/or other identifying information associated with the transaction. Additionally, the digital receipt request can identify a receipt template to be used and/or a file format for the digital receipt. The digital receipt request can be received by the receipt service 108, which retrieves a receipt template from the receipt template database 210. The receipt template that is retrieved may be based on the type of transaction and/or a receipt template identified in the digital receipt request. The receipt service 108 can retrieve the transaction information from the receipt template database 210 and generate the digital receipt using the receipt template, the transaction information, and any other associated information (e.g., bar code, date, etc.). A digital receipt file and/or a link (e.g., a hyperlink) to the digital receipt file may then be transmitted to a receipt delivery device (e.g., the website 216). Additionally or alternatively, the digital receipt file and/or the link to the digital receipt file can be transmitted to the user device 104 via a messaging service 222. For example, the digital receipt file and/or the link may be transmitted as a text message or an email, where the text message or the email includes a copy of the digital receipt file and/or provides the link to digital receipt file. The digital receipt file can be displayed in the website 216, the software application 214 (or another software application), or in the web viewer 218.

In some embodiments, a non-consumer user may use a monitoring application (app) 224 to display digital receipts. The non-consumer user can be a person on a management team or a security team of the product provider (e.g., a retailer). The monitoring application 224 may be used for asset protection, inventory management, and other operations.

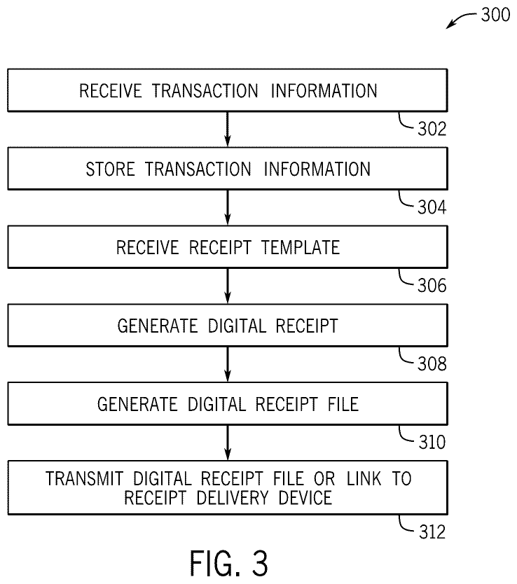

FIG. 3 illustrates a flowchart of a first example method 300 of generating digital receipts in accordance with an embodiment of the disclosure. The example method 300 may be performed at the end of an in-store transaction or an e-commerce transaction. At operation 302, the transaction information associated with a transaction is received. In one embodiment, receipt of the transaction information may include retrieving the transaction information from a memory device (e.g., from the receipt template database 210 of FIG. 2). In another embodiment, the transaction information can be received from a POS device or a user device (e.g., via a software application).

The transaction information may be associated with an in-store transaction or an e-commerce transaction. In one embodiment, the transaction information is received by a receipt service (e.g., the receipt service 108 of FIG. 1 or FIG. 2), which is implemented as or on a computing device (e.g., the computing device 900 of FIG. 9). For example, when the transaction is a purchase of one or more products, the transaction information can include a list of the product(s) purchased, a price for each product, a store identification (e.g., store name and telephone number), a date, a time, payment information, tax payment information, and any discounts or applied coupons (e.g., manufacturer coupon). When the transaction is a purchase of products under a government assistance program, the transaction information may include a list of the product(s) purchased, a price for each product, a store identification, a date, a time, and a beginning balance and an ending balance on the electronic benefits transfer (EBT) debit card. In another example, when the transaction is a return of a purchased product, the transaction information can include a list of the product(s) returned, a price for each returned product, payment refund information, a store identification, a date, a time, and a bar code.

The transaction information may also include a unique user identifier that can be used to correlate the transaction information to stored user information, such as a user profile. A POS device (e.g., POS device 202 in FIG. 2) may transmit the transaction information as the transaction is occurring or after the transaction is complete. In embodiments where the transaction is via e-commerce, the transaction information may be received from the software application 214 or the website 216 after checkout (e.g., after payment) or at another time.

At operation 304, the transaction information may be stored in a storage device (e.g., a memory). The memory may also store the unique user identifier with the transaction information to enable the transaction information to be retrieved. The user identifier can be associated with the user, a user account, and/or a user profile associated with the transaction. In one embodiment, the transaction information can be stored in a database that is stored in a memory (e.g., the receipt template database 210 of FIG. 2).

At operation 306, a desired receipt template is received. In one embodiment, receipt of the receipt template includes retrieving the desired receipt template from a memory device (e.g., from the receipt template database 210 of FIG. 2). For example, the desired receipt template may be selected and received based on some or all of the transaction information, such as a type of receipt or transaction (e.g., a purchase, a return, etc.).

At operation 308, a digital receipt is generated based on the desired receipt template and some or all of the transaction information received at operation 302. In some embodiments, the digital receipt is generated based on information in a user profile. For example, a user may specify a receipt template and/or a file format for a digital receipt. The receipt template is populated with the respective transaction information. In some embodiments, not all of the transaction information may be populated into the receipt template. For example, a gift receipt that is requested by a user may not include price information on the receipt and the transaction information related to price may be omitted when creating the digital receipt.

At operation 310, a digital receipt file is created. For example, a PDF or other type of electronic file is created that may include an image or other static representation of the digital receipt. The digital receipt file may be selected to be compatible or at least readable by different receipt delivery devices, such as printers, display screens, and the like.

At operation 312, the digital receipt file may be transmitted to a receipt delivery device, such as a printer (e.g., printers 204a, 204b, 304c, 204d of FIG. 2) and/or a computing device (e.g., user device 106 of FIG. 1). In other embodiments, a link to the digital receipt file is transmitted to the receipt delivery device (e.g., a user device). In some embodiments, the digital receipt file is transmitted to a receipt delivery device identified in a user profile. It should be noted that in some instances, the digital receipt file is the same regardless of the environment associated with the transaction and/or the receipt delivery device. For example, a user device may receive and view the same digital receipt file that was used to create a printed receipt. In this manner, the user may request at transaction time the receipt delivery device for the digital receipt, e.g., to request a digital copy only, omitting the printing step and saving paper and/or may request two types of formats, both digital and printed, and the two formats will include the same information in the same format.

The digital receipt file and/or the link to the digital receipt file may be transmitted to a computing device via one or more networks. For example, a computing device executing a receipt service (e.g., the receipt service 108 of FIG. 1 or FIG. 2) can transmit the receipt digital file or the link to a second computing device via the Internet or a messaging application (e.g., a short message service (SMS) application). In one embodiment, a user or a guest (e.g., a person who is not a registered user of an application or a rewards program) can receive a link in a message of the messaging application, where the link references an address on a network (e.g., a uniform resource locator). When the link is selected, a browser can open and display the digital receipt. In another embodiment, a mobile checkout device may not be able to access a receipt delivery device (e.g., the mobile checkout device 202c and the printer 208c of FIG. 2), such as when there is an issue with a network connection. In such situations, a user or a guest can receive an SMS message with a link to a page in a web browser that displays the digital receipt. The second computing device may be a user device (e.g., the user device 106 of FIG. 1) or a different computing device. When received at the second computing device, the digital receipt file can be viewed in a software application or via a website or web viewer executing on the second computing device.

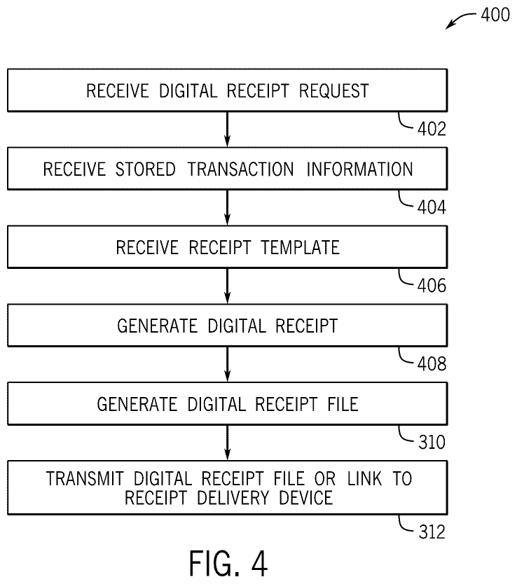

FIG. 4 illustrates a flowchart of a second example method 400 of generating digital receipts in accordance with an embodiment of the disclosure. In some implementations, a digital receipt can be generated after a transaction by a non-consumer user (e.g., a store employee). For example, a user may be able to receive a digital receipt after a certain amount of time has passed since the transaction. Non-limiting examples of the certain amount of time include twenty-four (24) hours, forty-eight (48) hours, a week, a month, or another time period.

Initially, as shown at operation 402, a digital receipt request is received. The digital receipt request can include one or more search terms that may include, for example, a product name, store information, a user identifier, a transaction identifier (e.g., an order or a receipt number), and/or a date. In some instances, the digital receipt request may further include a receipt delivery device to receive the digital receipt, a receipt template request, and/or a file format request for the digital receipt. For example, a POS device may request that a digital receipt be created for an in-store transaction using a particular type of receipt and/or a file format. As another example, a user device may request a digital receipt for an e-commerce transaction. The receipt template request may include the type of receipt template to be used, such as a purchase receipt, a gift receipt, a parking voucher, or the like. In some embodiments, the file format request can include a particular type of file format for the receipt. As described earlier, a receipt may be created as an Adobe® PDF file format, an HTML file format, a JPEG file format, or other file formats.

At operation 404, the stored transaction information associated with the information in the digital receipt request is received. In one embodiment, receipt of the transaction information can include retrieving the transaction information from a memory device (e.g., from the receipt template database 210 of FIG. 2). For example, the transaction information may be stored in the memory (e.g., the receipt template database 210 of FIG. 2) after completion of the transaction and retrieved at a later time for use in generating a digital receipt.

At operation 406, a stored receipt template is received. In one embodiment, receipt of the receipt template may include retrieving the desired receipt template from a memory device (e.g., from the receipt template database 210 of FIG. 2). In a non-limiting nonexclusive example, the receipt of the receipt template may be based on the type of receipt or transaction associated with the received transaction information, or on a receipt template request that can be included in the digital receipt request. The digital receipt is generated at operation 408 based on the receipt template, some or all of the transaction information, and a file format request if a file format request is included in the digital receipt request.

At operation 310, the digital receipt file is created. For example, a PDF or other type of electronic file is created that may include an image or other static representation of the digital receipt. At operation 312, the digital receipt file and/or a link to the digital receipt file is transmitted to a receipt delivery device. As described earlier, in some instances the digital receipt file is the same regardless of the environment associated with the transaction and/or the receipt delivery device.

The digital receipt file and/or the link to the digital receipt file may be transmitted to a computing device via one or more networks. For example, a computing device executing a receipt service (e.g., the receipt service 108 of FIG. 2) can transmit the receipt digital file and/or the link to a second computing device via the Internet. The second computing device may be a user device (e.g., the user device 106 of FIG. 1) or a different computing device. When received at the second computing device, the digital receipt file can be viewed in a software application or via a website or web viewer executing on the computing device.

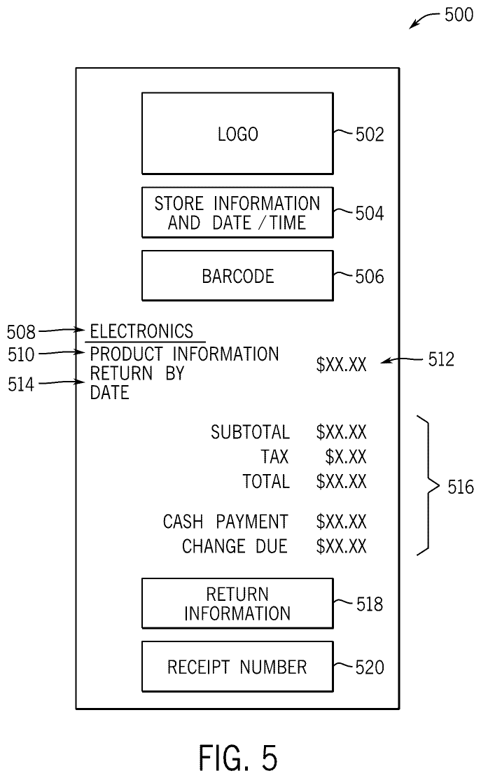

FIG. 5 illustrates an example printed in-store receipt in accordance with an embodiment of the disclosure. The example printed in-store receipt 500 is for a purchase of a product and includes a company or store logo 502, store information and a date/time of the transaction 504, and a bar code 506. The store information may include information such as a store number or name, an address, a telephone number, and the like, and the bar code 506 may be used to identify the transaction.

The printed in-store receipt 500 further includes a department header 508 that indicates a department associated with the product, and product information 510. The product information 510 may include a product identifier (e.g., a number) and a product name. A price 512 (e.g., a pre-tax price) for the product and a return-by-date 514 are also provided in the receipt. Payment information 516, return information, 518 and a receipt identifier 520 are listed on the receipt 500. The payment information 516 includes a subtotal for the purchase, an amount of tax owed, a total for the purchase, a form of payment (e.g., a cash payment), and an amount of change due. The return information 518 may describe a process for returning the product and/or a barcode that may be used for the return. The receipt number 520 provides an identifier for the receipt (e.g., a number). In other embodiments, the receipt 500 can include less or additional information, such as an informational notice, an amount saved, an amount applied from a gift card, a promotion, and the like.

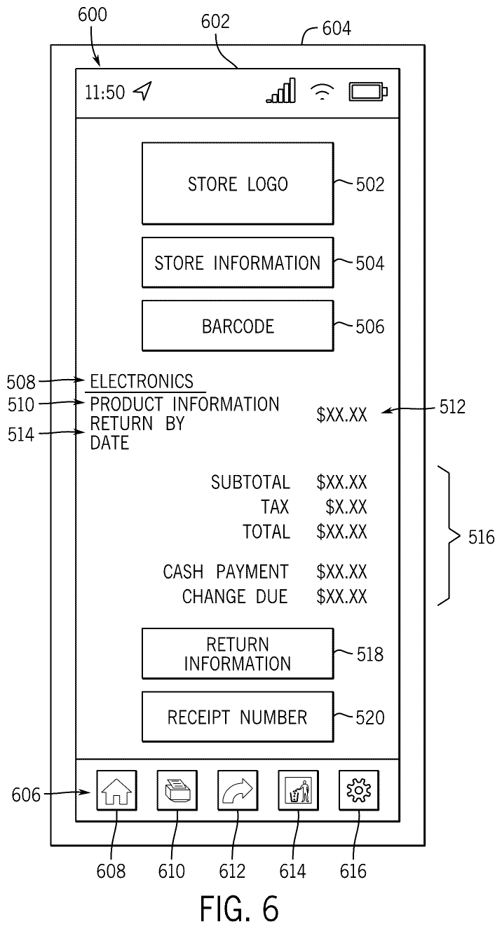

FIG. 6 illustrates the example in-store receipt 500 shown in FIG. 5 as a digital receipt 600 viewable in a user interface 602 on a display device 604 in accordance with an embodiment of the disclosure. The display device 604 can be a display device integrated with, or connected to a computing device (e.g., the user device 106 of FIGS. 1 and 2). The user interface 602 may include other features, such as one or more functional icons 606. When selected, a functional icon 606 causes a function associated with the functional icon to be performed. For example, the illustrated functional icons 606 represent a home function 608, a printing function 610, a share function 612, a delete or trash function 614, and a settings function 616. Additional or different functions may be included in other embodiments.

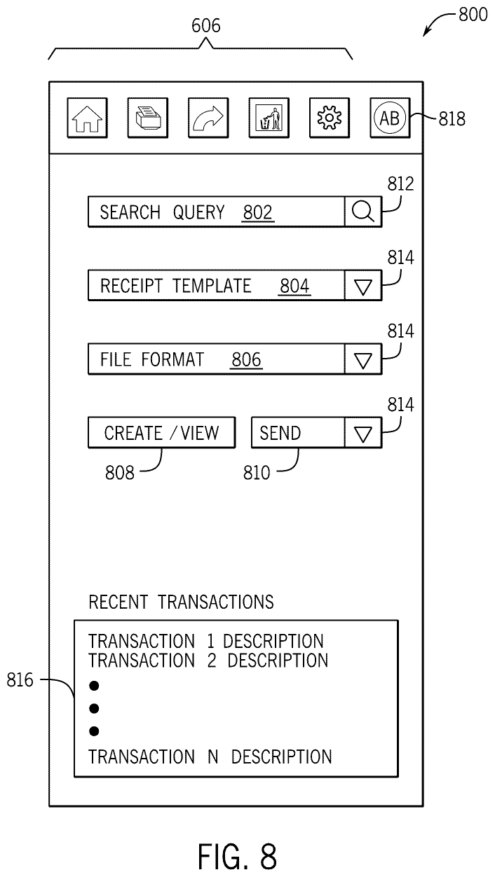

A receipt service, such as the receipt service 108 of FIG. 1 or FIG. 2, generates the digital receipt 600 to present all of the information included on the printed receipt 500 and in the same layout as the printed receipt 500. The receipt service may select a receipt template for the digital receipt 600 based on the information in the receipt, such as the transaction type (e.g., a purchase of a product), the barcode 506, the receipt number 520, or based on a selected receipt template included in a digital receipt request. An example user interface for requesting a digital receipt is shown and discussed in more detail in conjunction with FIG. 8.

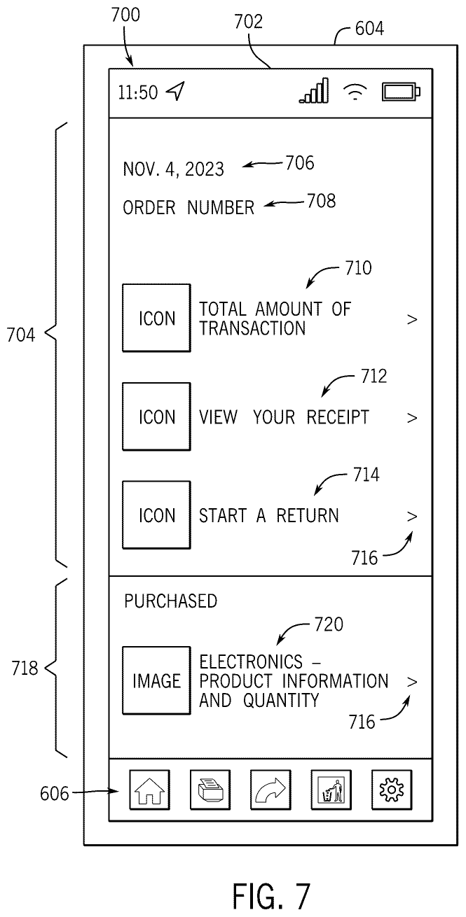

FIG. 7 illustrates an example of another digital receipt 700 viewed in a user interface 702 on the display device 604 in accordance with an embodiment of the disclosure. In one embodiment, the digital receipt 700 is associated with the purchase of an electronics product as shown in the printed receipt of FIG. 5 (e.g., 508 and 510 of FIG. 5). The purchase of the electronics product can be executed using a software application running on a user device (e.g., the software application 214 of FIG. 2) or as an in-store purchase at a physical store.

The example digital receipt 700 includes a first area 704 that includes a date 706, an order number 708, and three listings 710, 712, 714. The three listings 710, 712, 714 each include a graphical element and a description of “a total amount of the transaction” 710, a graphical element and a description of “view your receipt” 712, and a graphical element and a description of “start a return” 714. Each listing 710, 712, 714 further includes a right-pointing graphical element 716 that a user can click on (e.g., select) to receive further information. For example, clicking on the right-pointing graphical element 716 can cause a window to open and display additional information related to the description.

The example digital receipt 700 includes a second area 718 that lists information regarding the purchased products. In the illustrated embodiment, the information listing 720 associated with the purchased electronic product (e.g., 508 and 510 of FIG. 5) includes an image of the product, a product description, and a quantity purchased. The information listing 720 further includes the right-pointing graphical element 716 that a user can click on to receive further information about the product.

In one embodiment, a user may select the “view your receipt” listing 712 to request a digital receipt be generated. Upon selection of the “view your receipt” listing 712, a new digital receipt may be automatically generated, or another user interface can be provided to enable the user to request one or more attributes of the digital receipt. An example user interface for requesting a digital receipt is shown and discussed in more detail in conjunction with FIG. 8.

As described earlier, the digital receipt 700 may be generated during or immediately after the transaction is completed or some period of time after the purchase transaction is completed. A receipt service, such as the receipt service 108 of FIG. 1 and FIG. 2, generates the digital receipt 700 using a receipt template and the transaction information. The receipt service may select a receipt template for the digital receipt 700 based on the information in the receipt, such as the transaction type (e.g., a purchase of a product), the order number 708, or based on a receipt template that was selected by a user. In the illustrated embodiment, the digital receipt 700 has a different layout and different information compared to the digital receipt 600 shown in FIG. 6. Although both digital receipts 600, 700 are associated with the purchase of the same electronics product, the digital receipts 600, 700 were generated using different receipt templates and contain different information.

FIG. 8 illustrates an example user interface 800 for requesting a digital receipt in accordance with an embodiment of the disclosure. The user interface 800 includes a search query field 802, a receipt template field 804, a file format field 806, a create/view button 808, and a send field 810. A user can enter one or more search terms in the search query field 802 and select the control element 812 to search for a particular transaction. For example, the search term or terms can include a date, a user identifier, a transaction identifier (e.g., an order or receipt number), store information (e.g., a store address or identifier), a product name or description, a cost of a product (e.g., a pre-tax cost), and/or a total amount paid or returned. Different transaction information may be entered to search for a particular transaction in other embodiments.

The receipt template field 804 may be used by the user to select a particular receipt template for the digital receipt. In some embodiments, a window can open when a receipt template is selected to display the layout of the receipt template and the transaction information that will be included in the digital receipt. The file format field 806 enables a user to select a particular file format for the digital receipt. For example, the file format can be a PDF or an HTML file format. In the illustrated embodiment, the receipt template field 804 and the file format field 806 are configured as drop-down menus that can be displayed when a user or a cursor hovers or selects the control element 814. Different types of input options may be used in other embodiments. For example, radio buttons, text fields, and the like can be used.

Once a user has entered one or more search terms in the search query field 802, optionally selected a receipt template using the receipt template field 804, and optionally selected a file format using the file format field 806, the user can select the create/view button 808 to cause the digital receipt to be generated and displayed. A user can optionally send the digital receipt to another computing device, a printer, and/or a messaging application using the send field 810. In one embodiment, the send field 810 is configured as a drop-down menu that may be populated with one or more computing devices, e-mail addresses, smart phone numbers, individual names, and/or other contact information that the user can select to receive a copy of the digital receipt. Different types of input options may be used in other embodiments. For example, radio buttons, text fields, and the like can be used.

In some implementations, the example user interface 800 can display one or more recent transactions in a recent transaction area 816 to enable the user to select a recent transaction and generate a digital receipt. The transaction description displayed in the recent transaction area 816 may be some of the transaction information associated with the recent transaction. For example, a store name or other identifier, a product description, a receipt or order number, a date, a department header (e.g., the department header 508 of FIG. 5 and FIG. 6), an amount paid or returned, and/or the like may be included in the transaction description. In one embodiment, the digital receipt may be generated and displayed by the selection of a recent transaction by itself. Additionally or alternatively, the user can select the recent transaction, optionally select a receipt template using the receipt template field 804 and/or optionally select a file format using the file format field 806, and then select the create/view button 808. The user may also send the digital receipt of the recent transaction using the send field 810.

In some embodiments, the user interface 800 can include one or more of the functional icons 606 and/or a user profile icon 818. A user can select the user profile icon 818 to create and/or edit their user profile. The user profile may store information and/or user preferences associated with the user. For example, the user profile can store one or more of: preferred receipt delivery devices, preferred receipt templates, preferred file formats, and other user preferences. The one or more preferred receipt templates may be based on different transaction types or product types. Additionally or alternatively, the user profile can store information associated with the user, such as a user identifier, a name, contact information (e.g., an email address or a cell phone number), and/or a store preference. The user profile may be stored in a memory on a user device (e.g., the user device 106 in FIG. 1 or FIG. 2) and/or in another memory (e.g., in the database 922 stored in memory 920 in FIG. 9).

The systems, methods, and user interfaces disclosed herein may be implemented using various computing systems. FIG. 9 illustrates a block diagram of an example computing system 900 for implementing various embodiments in the examples described herein. For example, the receipt service 108 and the user device 106 shown in FIG. 1 or FIG. 2 may include or be implemented as the computing system 900. This disclosure contemplates any suitable number of computing systems 900. For example, the computing system 900 may be a server, a desktop computing system, a mainframe, a mesh of computing systems, a laptop or notebook computing system, a tablet computing system, an embedded computer system, a system-on-chip, a single-board computing system, or a combination of two or more of these. Where appropriate, the computing system 900 may include one or more computing systems; be unitary or distributed; span multiple locations; span multiple locations; span multiple machines; span multiple data centers; or reside in a cloud, which may include one or more cloud components in one or more networks.

Computing system 900 includes a first computing device 902 that includes one or more communication structures, such as a bus 904 (e.g., an address bus and a data bus) or other communication mechanism for communicating information, which interconnects subsystems and devices, such as memory 906, a display 908, a processor 910, an input/output device 912, a data storage interface 914, and a communications device 916. Although only one of each component is shown in FIG. 9, other embodiments can include one or more of the bus 904, the memory 906, the display 908, the processor 910, the input/output device 912, the data storage interface 914, and/or the communications device 916.

The memory 906 is configured to store information, such as data and software applications (collectively data 918). In one embodiment, the data 918 can include one or more user profiles and processor-executable instructions for one or more software applications. In another embodiment, the data 918 may include one or more user profiles, processor-executable instructions for one or more software applications, and one or more databases to store some or all of the receipt templates and/or the transaction information. The data 918 can include different or additional data in other embodiments. The memory 904 may be implemented as one or more types of volatile and non-volatile memory. For example, the memory 904 can be a read only memory (ROM), dynamic and/or static random-access memory (RAM), flash memory, cache memory, erasable programmable ROM (EPROM), electrically erasable programmable ROM (EEPROM), virtual memory, optical memory, magnetic memory, and combinations thereof.

In particular embodiments, the processor 910 includes hardware for executing processor-executable instructions, such as the instructions in a software application. The processor 910 includes circuitry for performing various processing functions, such as executing specific software for perform specific calculations or tasks. For example, the processor 910 may be implemented as a microprocessor, a central processing unit, a graphics processing unit, a neural processing unit, a digital signal processor, or combinations thereof.

The bus 904 can include one or more memory buses (which may each include an address bus and a data bus) that couple the processor 910 to the memory 906. In particular embodiments, one or more memory management units (MMUs) reside between the processor 910 and the memory 906 and facilitate accesses to the memory 906 as requested by the processor 910. In particular embodiments, the bus 904 includes hardware, software, or both coupling components of the computing device 902 to each other.

The display 908 includes circuitry and a display screen and is configured to present information on the display screen. The display 908 can be the display device 604 shown in FIG. 6 and FIG. 7, and may be used to display the digital receipts and graphical user interfaces described herein.

In particular embodiments, the I/O device 912 includes hardware, software, or both, providing one or more interfaces for communication between the I/O device 912 and other components within the computing device 902 and/or external to the computing device 902. One or more of the I/O devices 912 may enable communication between a user and the computing device 902. The I/O device 912 can include, but is not limited to, a keyboard, a keypad, a mouse, a microphone, speakers, input buttons, and combinations thereof. In some embodiments, the display 908 may also function as an I/O device when the display 908 is implemented as a touchscreen display that is configured to receive touch and/or force inputs as well as display information.

In particular embodiments, the communication device 916 includes hardware, software, or both providing one or more interfaces for communication (such as, for example, packet-based communication) between the computing device 902 and one or more other computing devices 920. Example communications devices 916 include, but are not limited to, a modem, an Ethernet card, a network interface controller (NIC) or network adapter for communicating with an Ethernet or other wire-based network, a wireless NIC (WNIC) or wireless adapter for communicating with a wireless network, such as a WI-FI network, and combinations thereof.

According to particular embodiments, the computing device 902 performs specific operations by the processor 910 executing one or more sequences of one or more processor-executable instructions stored in the memory 906. For example, processor-executable instructions for one or more of the graphical user interfaces, for a receipt service, for one or more software applications, a website, a web viewer, and/or one or more of the methods described herein may be stored in the memory 906 and may be executed by the processor 910. Such processor-executable instructions may be read into the memory 906 from another computer readable/usable medium, such as removable computer readable/usable medium (e.g., memory sticks, external hard drives). In alternative embodiments, hard-wired circuitry may be used in place of or in combination with processor-executable instructions. Thus, particular embodiments are not limited to any specific combination of hardware circuitry and/or software. In various embodiments, the term “logic” means any combination of software or hardware that is used to implement all, or part of particular embodiments disclosed herein.

The term “computer readable medium” or “computer usable medium” as used herein refers to any medium that participates in providing instructions to processor 910 for execution. Such a medium may take many forms, including but not limited to, nonvolatile media and volatile media.

The computing device 902 may transmit and receive messages, data, and instructions, including software applications (or processor-executable instructions) through a communications link 922 and the communications device 916. Received processor-executable instructions may be executed by the processor 910 as it is received, and/or stored in the memory 906 for later execution. In various examples, the communications link 922 may be configured as a network (e.g., the network 110 of FIG. 1) to enable the computing device 902 to communicate with, for example, user devices, POS devices, and receipt delivery devices (e.g., the user device 106 of FIG. 1 or FIG. 2 and (POS) devices 202 and receipt delivery devices 204 in FIG. 2).

The computing system 900 may further include one or more databases (database 924) that may be used to store data and/or software applications (collectively data 926). In one embodiment, the data 926 can include user profiles and processor-executable instructions for one or more software applications. In another embodiment, the data 926 may include user profiles, processor-executable instructions for one or more software applications, and some or all of the receipt templates and/or the transaction information. The data 926 can include different or additional data in other embodiments.

The database 924 can be accessed by the computing device 902 by way of the data storage interface 914 and/or the communications device 916. The database 924 can be stored in a memory 928 that is included in another computing device 930. The memory 928 may be implemented similar to the memory 906, and the computing device 930 can be implemented as the computing device 902. As such, the memory 928 and the computing device 930 are not described in detail.

The technology described herein may be implemented as logical operations and/or modules in one or more systems. The logical operations may be implemented as a sequence of processor-implemented steps executing in one or more computer systems and as interconnected machine or circuit modules within one or more computer systems. Likewise, the descriptions of various component modules may be provided in terms of operations executed or effected by the modules. The resulting implementation is a matter of choice, dependent on the performance requirements of the underlying system implementing the described technology. Accordingly, the logical operations making up the embodiments of the technology described herein are referred to variously as operations, steps, objects, or modules. Furthermore, it should be understood that logical operations may be performed in any order, unless explicitly claimed otherwise or a specific order is inherently necessitated by the claim language.

In some implementations, articles of manufacture are provided as computer program products that cause the instantiation of operations on a computer system to implement the procedural operations. One implementation of a computer program product provides a non-transitory computer program storage medium readable by a computer system and encoding a computer program. It should further be understood that the described technology may be employed in special purpose devices independent of a personal computer.

The above specification, examples and data provide a complete description of the structure and use of exemplary embodiments of as defined in the claims. Although various embodiments have been described above with a certain degree of particularity, or with reference to one or more individual embodiments, other embodiments using different combinations of elements and structures disclosed herein are contemplated, as other iterations can be determined through ordinary skill based upon the teachings of the present disclosure. It is intended that all matter contained in the above description and shown in the accompanying drawings shall be interpreted as illustrative only of particular embodiments and not limiting. Changes in detail or structure may be made without departing from the basic elements as defined in the following claims.

As used herein and unless otherwise indicated, the terms “a” and “an” are taken to mean “one”, “at least one” or “one or more”. Unless otherwise required by context, singular terms used herein shall include pluralities and plural terms shall include the singular.

Unless the context clearly requires otherwise, throughout the description and the claims, the words ‘comprise’, ‘comprising’, and the like are to be construed in an inclusive sense as opposed to an exclusive or exhaustive sense; that is to say, in the sense of “including, but not limited to”. Words using the singular or plural number also include the plural and singular number, respectively. Additionally, the words “herein,” “above,” and “below” and words of similar import, when used in this application, shall refer to this application as a whole and not to any particular portions of the application.

Of course, it is to be appreciated that any one of the examples, embodiments or processes described herein may be combined with one or more other examples, embodiments and/or processes or be separated and/or performed amongst separate devices or device portions in accordance with the present systems, devices and methods.

Finally, the above discussion is intended to be merely illustrative of the present system and should not be construed as limiting the appended claims to any particular embodiment or group of embodiments. Thus, while the present system has been described in particular detail with reference to exemplary embodiments, it should also be appreciated that numerous modifications and alternative embodiments may be devised by those having ordinary skill in the art without departing from the broader and intended spirit and scope of the present system as set forth in the claims that follow. Accordingly, the specification and drawings are to be regarded in an illustrative manner and are not intended to limit the scope of the appended claims.

What is claimed is:

1. A method for generating digital receipts, the method comprising:
receiving transaction information corresponding to a transaction conducted in an environment;
receiving, from a memory, a receipt template;
populating the receipt template to include at least a portion of the transaction information;
generating a digital receipt file based on the at least the portion of the transaction information and the receipt template; and
transmitting, over a network to a receipt delivery device, the digital receipt file.

2. The method of claim 1, wherein the environment is a physical store and the receipt delivery device comprises a printer positioned within the physical store.

3. The method of claim 1, wherein receiving the transaction information corresponding to the transaction comprises receiving, from a point of sale device positioned within the physical store, the transaction information corresponding to the transaction.

4. The method of claim 1, wherein the environment is an e-commerce environment and the receipt delivery device comprises a computing device.

5. The method of claim 4, wherein the e-commerce environment comprises a website.

6. The method of claim 4, wherein the e-commerce environment comprises a software application operating on a computing device.

7. The method of claim 4, wherein receiving the transaction information corresponding to the transaction comprises receiving, over a network from the computing device, the transaction information corresponding to the transaction.

8. The method of claim 1, wherein receiving, from the memory, the receipt template comprises:
based on the transaction information, selecting the receipt template from the memory; and
receiving, from the memory, the selected receipt template.

9. The method of claim 8, wherein:
the transaction information comprises a transaction type; and
the receipt template is selected based on the transaction type.

10. The method of claim 1, wherein receiving, from the memory, the receipt template comprises based on a digital receipt request received from a computing device, receiving the receipt template from the memory, wherein the digital receipt request includes a selection of the receipt template.

11. A method for generating digital receipts, the method comprising:
receiving, over a network from a computing device, a digital receipt request;
receiving, from a memory, transaction information associated with the digital receipt request;
receiving, from the memory, a receipt template;
populating the receipt template to include at least a portion of the transaction information;
generating a digital receipt file based on the at least the portion of the transaction information and the receipt template; and
transmitting, over the network to the computing device, the digital receipt file or a link to the digital receipt file.

12. The method of claim 11, wherein:
the digital receipt request comprises a selected file format; and
receiving, from the memory, the receipt template comprises receiving, from the memory, the selected receipt template.

13. The method of claim 11, wherein:
the digital receipt request comprises a selected file format; and
generating the digital receipt file comprises generating the digital receipt file in the selected file format.

14. The method of claim 11, wherein:
the digital receipt request comprises one or more search terms; and
receiving, from the memory, the transaction information associated with the digital receipt request comprises receiving, from the memory, transaction information associated with a search for transaction information based on the one or more search terms.

15. The method of claim 11, wherein receiving, from the memory, the receipt template comprises:
based on the transaction information, selecting the receipt template from the memory; and
receiving, from the memory, the selected receipt template.

16. The method of claim 11, wherein:
the digital receipt request identifies a transaction associated with the transaction information; and
receiving, from the memory, the transaction information associated with the digital receipt request comprises receiving, from the memory, the transaction information associated with the identified transaction.

17. A system, comprising:
a processor; and
a memory configured to store:
a database configured to store a plurality of receipt templates; and
processor-executable instructions, that when executed by the processor, cause operations to be performed, the operations comprising:
receiving transaction information corresponding to a transaction;
receiving, from the database, a receipt template of the plurality of receipt templates;
populating the receipt template to include at least a portion of the transaction information;
generating a digital receipt file based on the at least the portion of the transaction information and the receipt template; and
transmitting, over a network to a receipt delivery device, the digital receipt file.

18. The system of claim 17, wherein:
the database is a first database;
the memory is configured to store a second database configured to store transaction information associated with a plurality of transactions; and
receiving transaction information corresponding to the transaction comprises receiving, from the second database, the transaction information corresponding to the transaction.

19. The system of claim 17, wherein:
the memory is configured to store user profiles; and
receiving, from the database, the receipt template comprises receiving, from the database, the receipt template based on a user profile associated with a user that executed the transaction.

20. The system of claim 17, wherein:
receiving the transaction information corresponding to the transaction comprises receiving, over a network from a computing device, the transaction information corresponding to the transaction; and
the receipt delivery device comprises the computing device.
